(19) United States
(12) Patent Application Publication
(10) Pub. No.: US 2007/0102354 A1
(43) Pub. Date: May 10, 2007

(54) SYSTEM FOR TREATING WASTEWATER AND A MEDIA USABLE THEREIN

(76) Inventors: Wayne J. Flournoy, Chapel Hill, NC (US); Richard L. Pehrson, Limerick, PA (US)

Correspondence Address: SMITH MOORE LLP, P.O. BOX 21927, GREENSBORO, NC, 27420, US

(21) Appl. No.: 11/552,778

(22) Filed: Oct. 25, 2006

Related U.S. Application Data
(60) Provisional application No. 60/730,488, filed on Oct. 26, 2005.

(51) Int. Cl. C02F 3/02

(52) U.S. Cl. 210/614; 210/616; 210/151; 210/620

(57) ABSTRACT

A wastewater treatment system and a biological reactor usable in a wastewater treatment system are disclosed. Also disclosed is a media for supporting a growth biology and usable in a biological reactor. Each media includes a tubular cross-section and perturbated outer perimeter, which may be non-nesting. The perturbated outer perimeter creates a protected outer surface area for supporting a growth biology. Also disclosed is a screen sized so as to facilitate retention of the number of media within the biological reactor.

This application claims the benefit of U.S. Provisional Application No. 60/730,488, filed Oct. 26, 2005.

In the accompanying drawings:

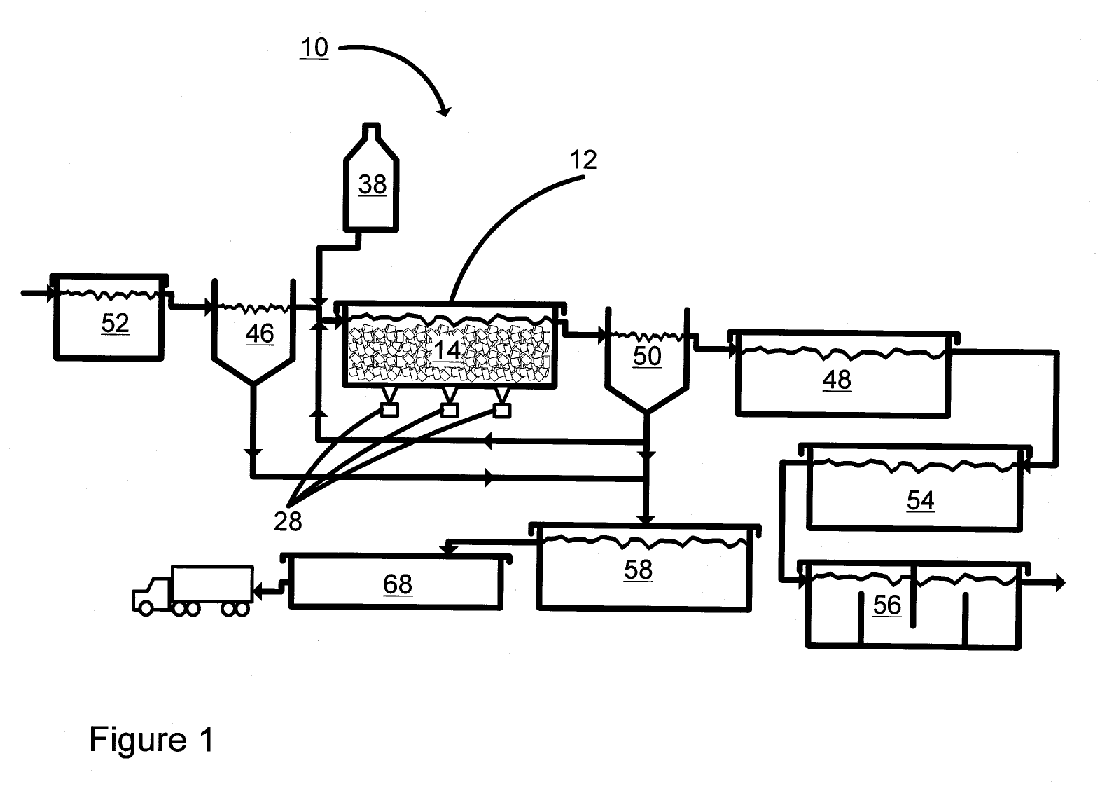

FIG. 1 is a diagram illustrating a wastewater treatment system according to an aspect of the present invention;

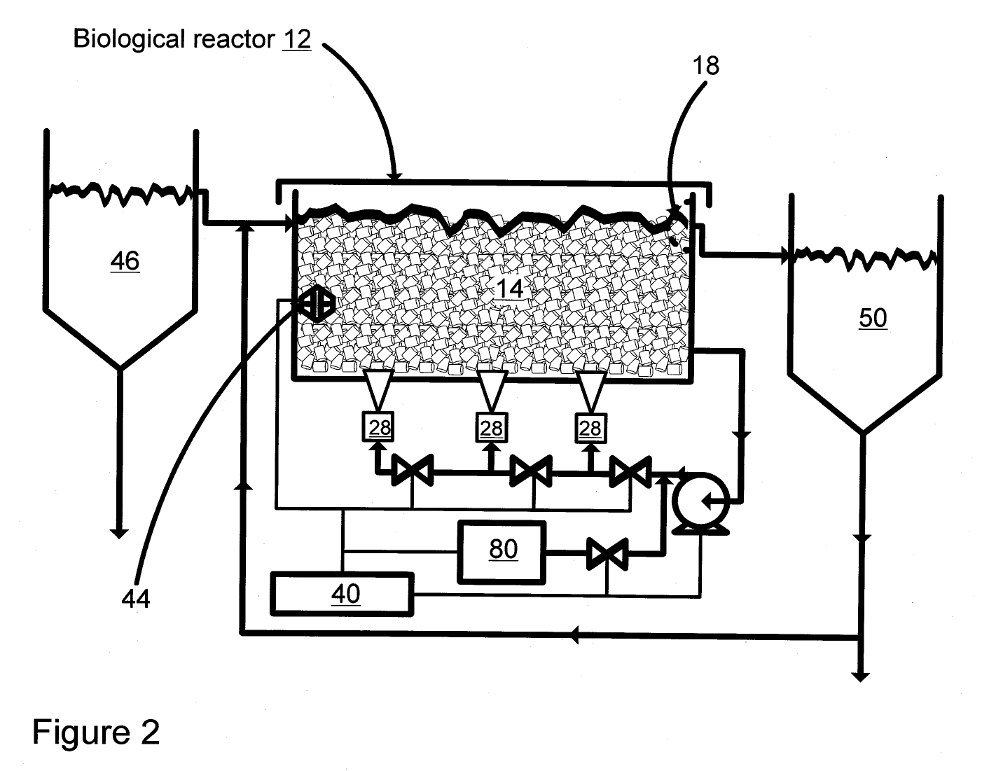

FIG. 2 is a diagram illustrating, among other things, an example of a biological reactor according to an aspect of the present invention and usable with a wastewater treatment system of FIG. 1;

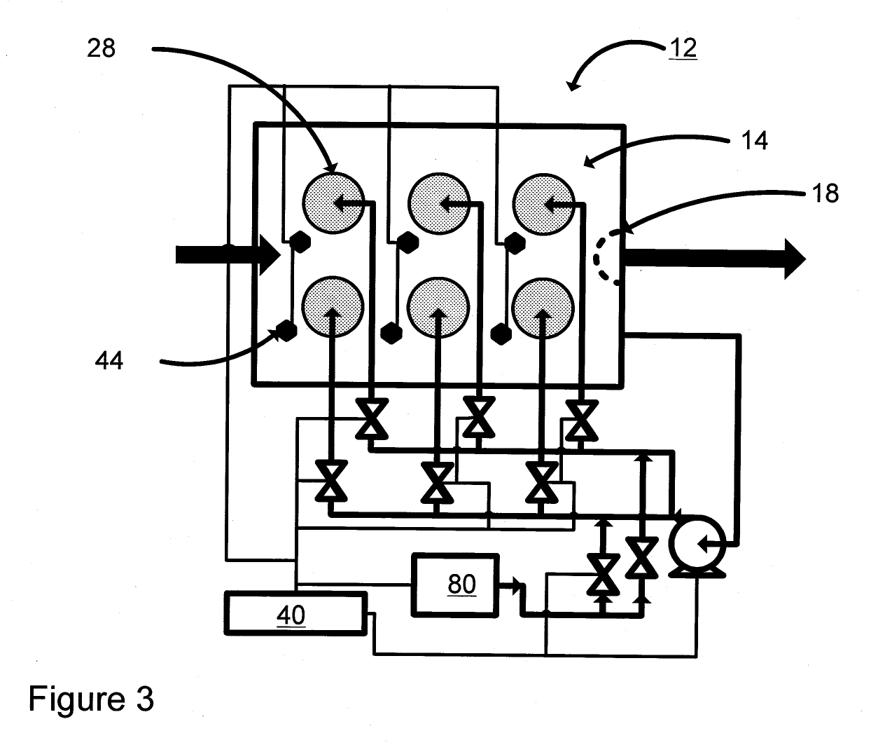

FIG. 3 is a diagram illustrating, among other things, a top view of the biological reactor of FIG. 2 according to an aspect of the present invention and usable with a wastewater treatment system of FIG. 1;

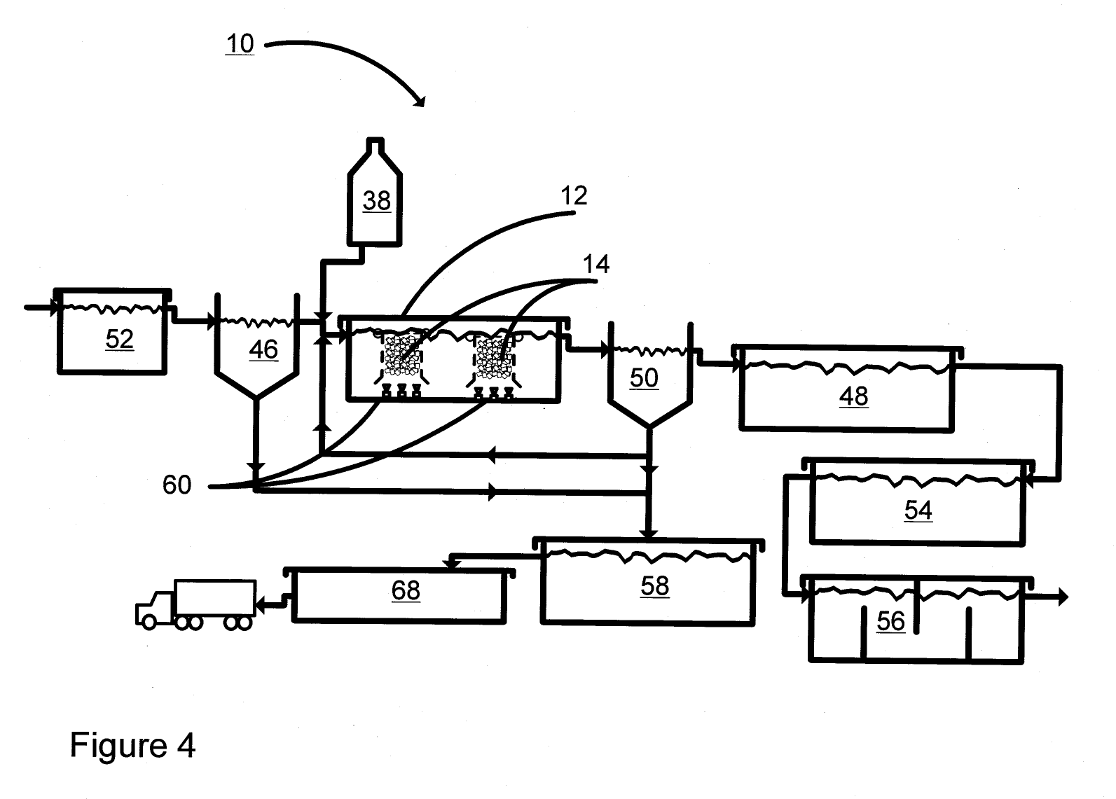

FIG. 4 is a diagram illustrating a wastewater treatment system according to another aspect of the present invention;

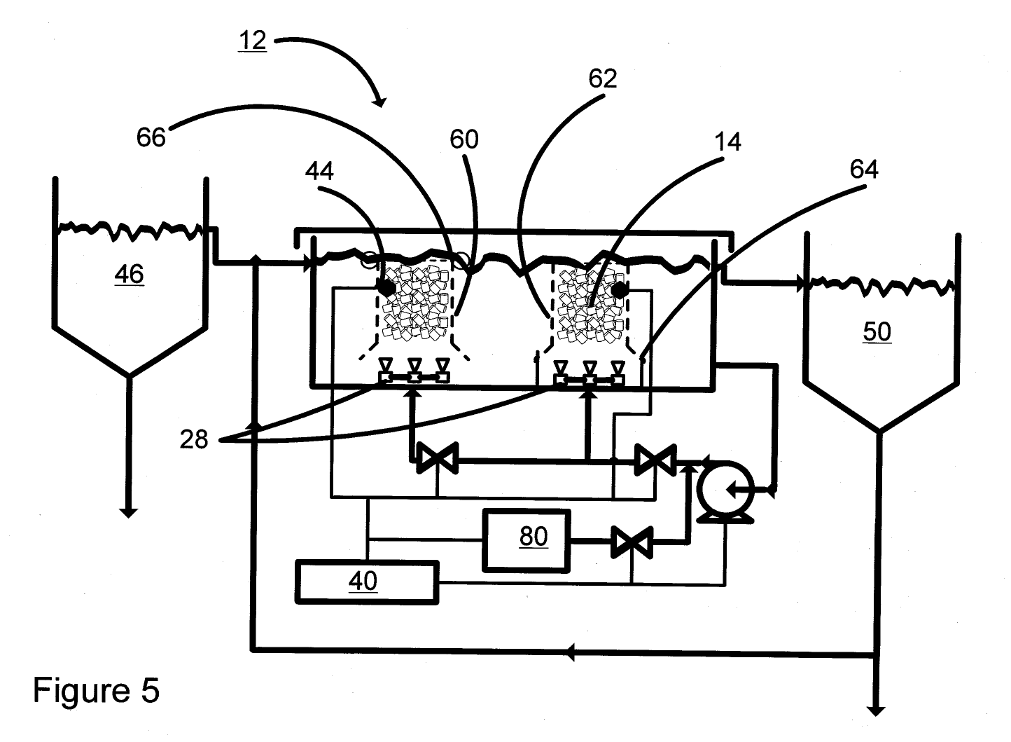

FIG. 5 is a diagram illustrating, among other things, an example of a biological reactor according to an aspect of the present invention and usable with a wastewater treatment system of FIG. 4;

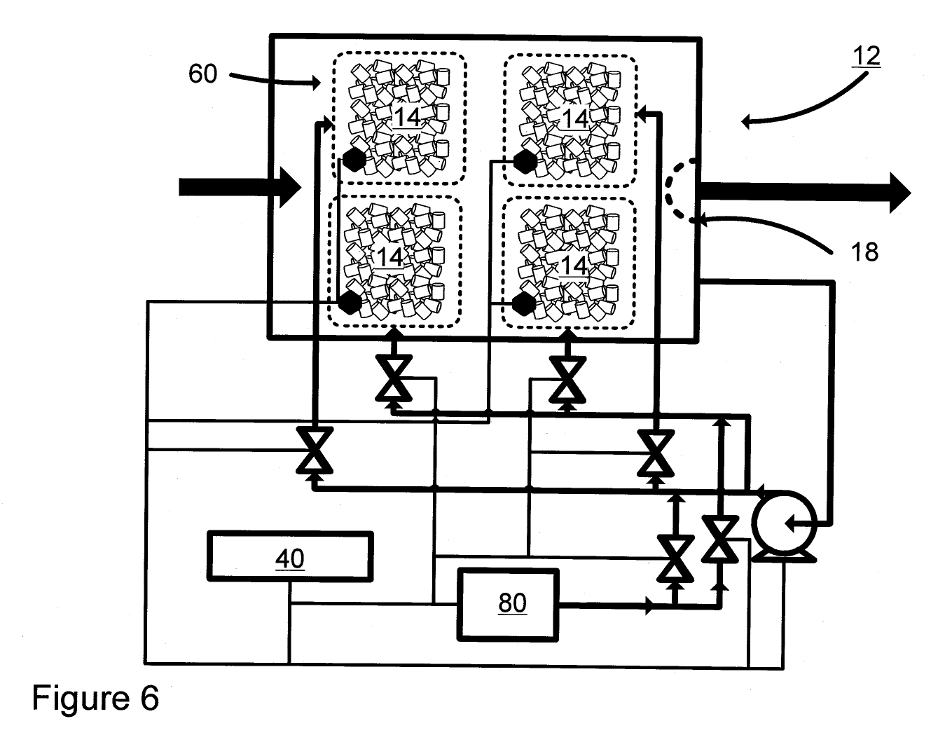

FIG. 6 is a diagram illustrating, among other things, a top view of the biological reactor of FIG. 5 according to an aspect of the present invention and usable with a wastewater treatment system of FIG. 4;

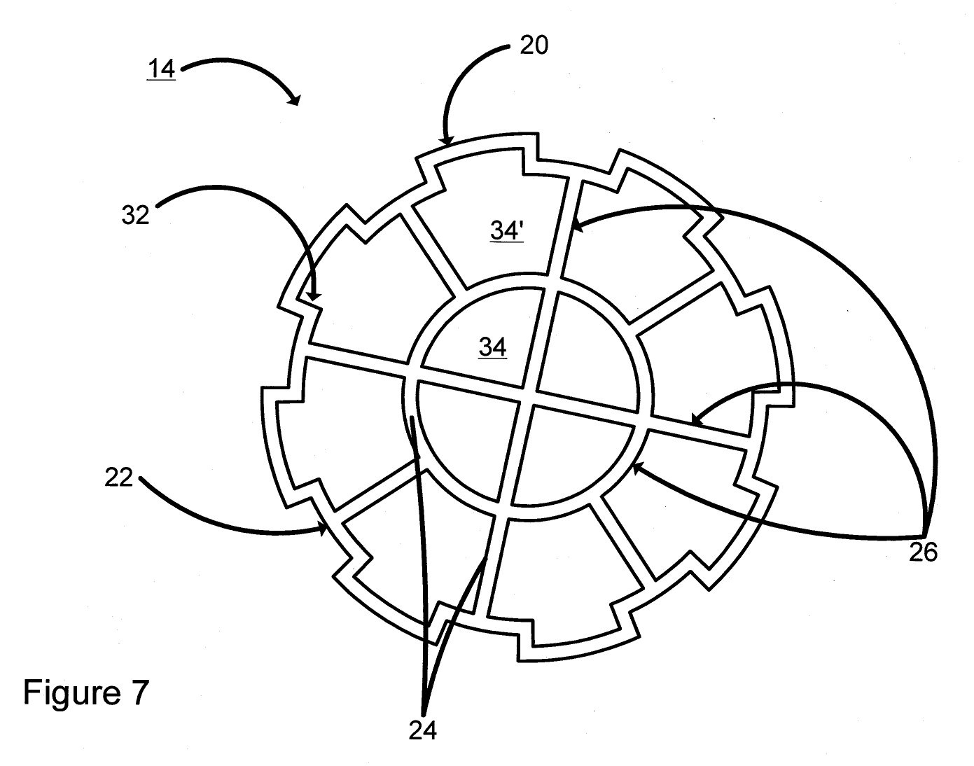

FIG. 7 is a diagram illustrating a cross-section of media for supporting a growth biology within a biological reactor and usable with a biological reactor of FIG. 1, FIG. 2, FIG. 3, FIG. 4, FIG. 5, FIG. 6, or any combination of any of the preceding;

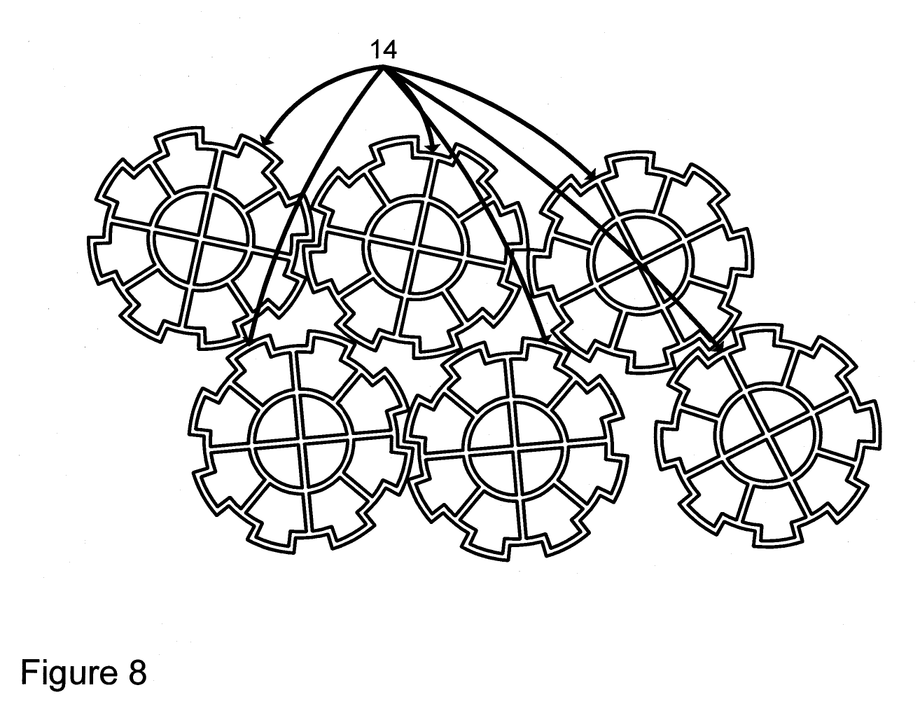

FIG. 8 is a diagram illustrating a plurality of media for supporting a growth biology within a biological reactor and usable with a biological reactor of FIG. 1, FIG. 2, FIG. 3, FIG. 4, FIG. 5, FIG. 6, FIG. 7, or any combination of any of the preceding;

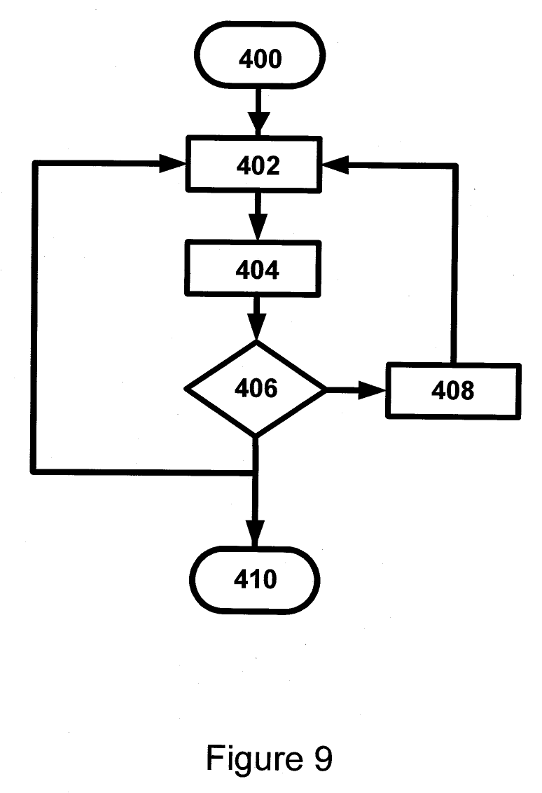

FIG. 9 is a diagram illustrating an example of a control algorithm usable with the biological reactor of FIGS. 1, 2, and 3 and/or the biological reactor including controlled-reaction-volume modules of FIGS. 4, 5, and 6, either including a media, such as, for example, that shown in FIGS. 7 and 8, for supporting a supporting a growth biology;

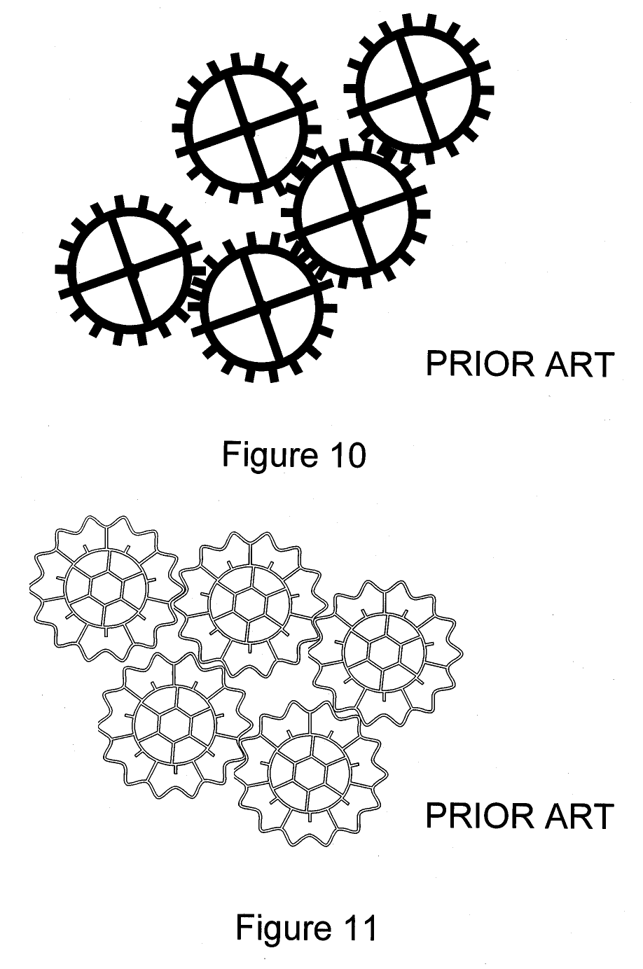

FIG. 10 is a diagram illustrating a cross-section of a prior art media; and

FIG. 11 is a diagram illustrating a cross-section of a prior art media.

The present invention is directed towards a number of aspects and/or embodiments connected with a wastewater treatment system and/or a biological reactor usable in a wastewater treatment system and/or a media for supporting a growth biology including, without limitation, any one of a wastewater treatment system, a biological reactor usable in a wastewater treatment system, a media for supporting a growth biology, a method for treating wastewater, a method for supporting a growth biology, or any combination of any of the preceding.

Applicant includes the following scenario to provide an understanding of the present invention. It should be understood that the present invention may apply to any one of a wastewater treatment system, a biological reactor usable in a wastewater treatment system, a media for supporting a growth biology, a method for treating wastewater, a method for supporting a growth biology, or any combination of any of the preceding and is not limited to the following scenario.

Wastewater treatment is driven by the desire to renovate wastewater before it re-enters a body of water, is applied to the land, is reused, or any combination of any of the preceding to prevent pollution of lakes, rivers, and/or streams. Too many organics, which act as food for a growth biology, and/or too many nutrients, which feed growth biology, in lakes, rivers, and/or streams are able to support growth biology. In turn, growth biology is able to consume available oxygen to, in effect, suffocate wildlife normally found in the in lakes, rivers, and/or streams. Wastewater treatment seeks to reduce this food (organics) and/or these nutrients prior to discharging to levels that permit available oxygen in lakes, rivers, and/or streams to be at levels that support wildlife. Also, wastewater treatment seeks to disinfect (usually with chlorine) to prevent the spread of human pathogens (typically virus and bacteria).

Organics are the carbon-hydrogen compounds predominately formed as the result of biological activity. These compounds come in a wide variety of forms. To provide a measure of the amount of organic compounds, the industry has settled on the use of “Biochemical Oxygen Demand” or BOD (normally referred to as five-day BOD, or BOD5), which simply means the quantity of oxygen consumed by a sample spiked with growth biology over a five-day period. It is an indirect measure of the organic content.

Nutrients of interest are similar to those used to fertilize a lawn: phosphorus (P) and nitrogen (N). Nitrogen is typically present in the form of ammonia (NH₃), which is broken down under aerobic conditions to nitrite and nitrate (NO₂ and NO₃). These in turn may be reduced to elemental nitrogen by treating under conditions without oxygen (called anoxic when NO₃ is present). Normally, wastewater is treated under oxic conditions, although certain high strength wastes (typically industrial) are most efficiently treated in the absence of any source of oxygen (air or NO₃), a condition called anaerobic. Also, wastewater may be treated in the absence of oxygen in its elemental form, but with NO₂ and/or NO₃ present to provide a source of oxygen, a condition called anoxic.

Thus, the goal of wastewater treatment may be summarized as:

| Offending | | |
|---|---|---|
| Constituent | Measured as | Treated by |
| Solids | TSS (Total | Settling out in a clarifier |
| | Suspended Solids) | |
| Organics | BOD | Biological oxic (Anaerobic |
| | | for high strength) |
| Phosphorus | P | Biological or by use of |
| | | chemicals |
| Ammonia | NH₃ | Biological oxic (reduced to |
| | | NO₂/NO₃) |
| Nitrates/Nitrites | NO₂/NO₃ | Biological anoxic |
| Pathogens | — | Chlorine, Ultraviolet, Ozone |

The means of treatment is to provide food (BOD), nutrients (P & N, both normally present in sufficient quantities for cell growth), and oxygen for growth biology that does the bulk of the treatment. Wastewater treatment may be thought of as creating a comfortable home for the growth of beneficial growth biology to treat the wastes. To accomplish this end, a wastewater treatment system that typically looks similar to that shown in FIG. 1 is built to include a biological reactor.

Sewage is the wastewater released by residences, businesses, and industries in a community. Typical municipal wastewater is about 99.94 percent water, with only about 0.06 percent of the wastewater dissolved and suspended solid material. Industrial wastewater may be considerably higher. Cloudiness of sewage is caused by suspended particles which, in untreated municipal sewage, typically range between about 100 milligrams per liter (mg/l) and 350 mg/l. As noted above, a measure of the strength of the wastewater is BOD (normally referred to as 5 day BOD, or BOD5) that measures the amount of oxygen microorganisms (growth biology) require in five days to break down sewage. Untreated municipal sewage typically has a BOD ranging between about 100 mg/l and 300 mg/l. Pathogens or disease-causing organisms are present in municipal sewage. Coliform bacteria are used as an indicator of disease-causing organisms. Sewage also contains nutrients (such as ammonia and phosphorus), minerals, and metals. Ammonia can range between about 12 mg/l and 50 mg/l, and phosphorus can range between about 6 mg/l and 20 mg/l in untreated sewage.

Referring now to FIG. 1, wastewater treatment is a multi-stage process (e.g., including preliminary treatment, primary treatment, secondary treatment, final treatment, and, optionally, advanced treatment) to renovate wastewater before it re-enters a body of water, is applied to the land, is reused, or any combination of any of the preceding. The goal is to reduce or remove organic matter, solids, nutrients, disease-causing organisms, and other pollutants from wastewater. Each receiving body of water has limits to the amount of pollutants it can receive without degradation. Each municipal wastewater treatment plant holds a permit listing the allowable levels of BOD, suspended solids, coliform bacteria, and other pollutants. The discharge permits are called NPDES permits, which stands for the National Pollutant Discharge Elimination System. Industrial wastewater treatment plants that have direct stream discharges also have NPDES permits. Industrial plants that discharge into municipal plants have site-specific pretreatment limits.

Preliminary Treatment: Preliminary treatment to screen out, grind up, or separate debris is usually the first step in wastewater treatment. Sticks, rags, large food particles, sand, gravel, toys, etc., are removed at this stage to protect the pumping and other equipment in the treatment plant. Treatment equipment such as bar screens, comminutors (a large version of a garbage disposal), and grit chambers are commonly used as the wastewater first enters a treatment plant. The collected debris is usually disposed of in a landfill.

Primary Treatment: Primary treatment is usually the second step in treatment and separates suspended solids and greases from wastewater. Wastewater is held in a quiet tank for several hours, allowing the particles to settle to the bottom and the greases to float to the top. The solids drawn off the bottom and skimmed off the top receive further treatment as sludge. The clarified wastewater flows on to the next stage of wastewater treatment. Clarifiers and septic tanks are usually used to provide primary treatment.

Secondary Treatment: Secondary treatment is a biological treatment process to remove dissolved organic matter, and often, nutrients from wastewater. Sewage microorganisms (growth biology) are cultivated and added to the wastewater. The microorganisms (growth biology) absorb organic matter from sewage as their food supply. Three approaches are predominately used to accomplish secondary treatment: fixed film, suspended film growth, and lagoon systems.

Fixed Film Systems: Fixed film systems grow microorganisms (growth biology) on substrates such as rocks, sand, or plastic. The wastewater is spread over the substrate, allowing the wastewater to flow past the film of microorganisms (growth biology) fixed to the substrate. As organic matter and nutrients are absorbed from the wastewater, the film of microorganisms (growth biology) grows and thickens. Trickling filters, rotating biological contactors, and sand filters are examples of fixed film systems.

Suspended Film Growth Systems: Suspended film growth systems stir and suspend microorganisms (growth biology) in wastewater. As the microorganisms (growth biology) absorb organic matter and nutrients from the wastewater, they grow in size and number. After the microorganisms (growth biology) have been suspended in the wastewater for several hours, they are settled out as a sludge. Some of the sludge is pumped back into the incoming wastewater to provide “seed” microorganisms (growth biology). The remainder is wasted and sent on to a sludge treatment process. Activated sludge, extended aeration, oxidation ditch, and sequential batch reactor systems are all examples of suspended film systems.

Lagoon Systems: Lagoon systems are normally large, relatively shallow basins that hold the wastewater for a few days to several months to allow for the natural degradation of sewage. These systems may be aerated artificially or take advantage of natural aeration and microorganisms (growth biology) in the wastewater to renovate sewage.

Integrated Fixed-Film/Activated Sludge (IFAS) System: IFAS systems combine suspended microorganisms (growth biology) with fixed microorganisms (growth biology). A media of the present invention may be used as a carrier for the fixed microorganisms (growth biology) portion of an IFAS systems.

Final Treatment: Final treatment focuses on removal of disease-causing organisms from wastewater. Treated wastewater can be disinfected by adding chlorine or by using ultraviolet light. High levels of chlorine may be harmful to aquatic life in receiving streams. Treatment systems often add a chlorine-neutralizing chemical to the treated wastewater before stream discharge.

Advanced Treatment: Advanced treatment is necessary in some treatment systems to remove nutrients from wastewater. Chemicals are sometimes added during the treatment process to help settle out or strip out phosphorus or nitrogen. Some examples of nutrient removal systems include coagulant addition for phosphorus removal and air stripping for ammonia removal.

Sludges: Sludges are generated through the wastewater treatment process. Primary sludges, material that settles out during primary treatment, often have a strong odor and require treatment prior to disposal. Secondary sludges are predominately the extra microorganisms (growth biology) from the biological treatment processes. The goals of sludge treatment are to stabilize the sludge and reduce odors, remove some of the water and reduce volume, decompose some of the organic matter and reduce volume, kill disease causing organisms, and disinfect the sludge.

Untreated sludges are about 97 percent water. Settling the sludge and decanting off the separated liquid removes some of the water and reduces the sludge volume. Settling can result in a sludge with between about 96 to 92 percent water. More water can be removed from sludge by using sand-drying beds, vacuum filters, filter presses, and centrifuges resulting in sludges with between about 80 to 50 percent water. This dried sludge is called a sludge cake. Aerobic and anaerobic digestion are used to decompose organic matter to reduce volume. Digestion also stabilizes the sludge to reduce odors. Caustic chemicals can be added to sludge, or it may be heat-treated to kill disease-causing organisms. Following treatment, liquid and cake sludges are taken to landfills or usually spread on fields, returning organic matter and nutrients to the soil.

Wastewater treatment processes require careful management to ensure the protection of the water body that receives the discharge. Trained and certified treatment plant operators measure and monitor the incoming sewage, the treatment process, and the final effluent.

In the following description, like reference characters designate like or corresponding parts throughout the several views. Also in the following description, it is to be understood that such terms as “forward,” “rearward,” “left,” “right,” “upwardly,” “downwardly,” and the like are words of convenience and are not to be construed as limiting terms.

Referring now to the drawings in general, and FIGS. 1 and 4 in particular, it will be understood that the illustrations are for the purpose of describing one or more aspects and/or embodiments of the invention and are not intended to limit the invention thereto. As seen in FIGS. 1 and 4, a wastewater treatment system, generally designated 10, is shown according to the present invention. The wastewater treatment system 10 includes a biological reactor 12. A number of a media 14 for supporting growth biology are located in the biological reactor 12. As may be seen in FIGS. 7 and 8, each media 14 includes a tubular cross-section 16 and a perturbated outer perimeter 20. As may be seen in FIG. 8, the perturbated outer perimeter 20 may be non-nesting. Also as seen in FIGS. 7 and 8, the perturbated outer perimeter 20 may include a stepwise perturbation or a unit stepwise perturbation. The perturbated outer perimeter 20 creates a protected outer surface area 22 for supporting growth biology.

Although not necessarily shown in FIGS. 7 and 8, in an aspect of the present invention, a tubular cross-section 16 may include any one of an oval cross-section, an elliptical cross-section, a polygonal cross-section, or any combination of any of the preceding. Nonlimiting examples of an oval cross-section may include any one of an egg cross-section, a track cross-section, or any combination of any of the preceding. Nonlimiting examples of an elliptical cross-section include a circular cross-section. Nonlimiting examples of an polygonal cross-section may include any one of a simple polygonal cross-section, complex polygonal cross-section, a convex polygonal cross-section, a concave polygonal cross-section, a concyclic or cyclic polygonal cross-section, a regular polygonal cross-section (e.g., triangle, rectangle, pentagon, hexagon, heptagon, . . . etc. may refer to either regular or non-regular polygons), or any combination of any of the preceding.

Turning again to FIGS. 7 and 8, in an aspect of the present invention, a media 14 further may include an interior structure 24 capable of creating an interior surface area 26 for supporting growth biology. At least a portion of the interior surface area 26 may include a potion of the perturbated outer perimeter 20. Also, portions of an interior structure 24 may provide support to the outer perimeter 20.

In an aspect of the present invention, an interior structure 24 may include a distribution within the outer perimeter 20 so as to substantially avoid a bridging of growth biology in a space 34 defined by an interior structure 24 and/or the outer perimeter 20. Also, portions of the interior surface area 26 may include interior perturbated surface area 32. Also, an interior perturbated surface area 32 may include a distribution so as to substantially avoid a bridging of growth biology in a space 34′ defined by an interior structure 24 and/or the outer perimeter 20.

In another aspect, a perturbated outer perimeter 20 may facilitate a mixing of the media 14. A mixing of the media 14 may include any one of a tumbling of the media 14, a rotating of the media 14, or a tumbling and a rotating of the media 14. In yet another aspect, a media 14 may include an aspect ratio (nominal length to nominal diameter ratio) of between about 0.3 and about 1. Also, media 14 may be made to any size that would facilitate growth biology, such as, for example, a nominal diameter ranging between about 0.3 inch and about 1.5 inches.

Once again turning to FIGS. 7 and 8, in an aspect of the present invention, a protected outer surface area 22 for supporting growth biology may include between about 30 to about 70 percent of the exterior surface area of the media 14. In another aspect, the protected outer surface area 22 for supporting growth biology may include between about 40 to about 60 percent of the exterior surface area. Further, an exterior surface may include an arrangement so as to substantially avoid a bridging of growth biology in a space 34′ defined by the perturbated outer perimeter 20.

In an aspect of the present invention, a media 14 is substantially neutrally buoyant in the wastewater being treated. A manner of achieving such neutral buoyancy may be by manufacturing a media 14 so as to have a specific gravity of between about 0.8 and about 1.2. To that end, a media 14 may be manufactured using a polymer, such as, for example, any one of polyolefin, such as, for example, any one of a polyethylene, a polypropylene, a polyvinylchloride, or any combination of any of the preceding. A media 14 may be manufactured by any one of injection molding, extrusion, or the like.

Turning now to a biological reactor 12, as shown in FIGS. 1, 2, 3, 4, 5, and 6, it may further include at least one screen 30 sized so as to facilitate retention of the number of media 14 therewithin. Such screen 30 may be sized with openings smaller than the smaller dimension of a media 14. For example, an opening of the screen 30 may be about ⅔ of the smaller dimension of a media 14. A screen 30 may be constructed using a material possessing corrosion resistance, such as, for example, stainless steel. Also, a screen 30 may be constructed of any one of a wedgewire, a round wire, a perforated and expanded metal, or any combination of any of the preceding.

A wastewater treatment system 10, in addition to at least one biological reactor 12, may further include any one of a chemical supply 38, one or more clarifier(s) 46 and 50, a headworks 52, a filter 48, a disinfector 54, an aerator 56, or any combination of any of the preceding. As shown in FIGS. 1 and 4, one clarifier 46 may be upstream from the biological reactor 12 while an additional clarifier 50 may be downstream. A headworks 52 may be upstream from the biological reactor 12 while a filter 48 may be downstream. Also downstream from the biological reactor 12 may be a disinfector 54 and/or an aerator 56.

Applicant contemplates that a wastewater treatment system 10 of the present invention may be any one of a municipal wastewater treatment facility, an industrial wastewater treatment facility, a commercial wastewater treatment facility, a ship wastewater treatment facility, an agricultural wastewater treatment facility, or any combination of any of the preceding.

Again turning to a biological reactor 12 as shown in FIGS. 1, 2, 3, 4, 5, and 6, it may further include any one of a mixing device 28, a controller 40, a sensor 44, a controlled-reaction-volume module 60 (e.g., see FIGS. 4, 5, and 6), a pump, a gas supply 80, or any combination of any of the preceding.

As FIGS. 1 and 3 are a block diagram of a typical wastewater treatment system 10, specific unit operations that are not shown may be present. FIGS. 1 through 8 are not to be encompassing of all options, but for example purposes. The headworks 52 may include screening and grit removal that takes large materials and grit (sand and gravel) out of the wastewater for disposal typically in landfills. Screens typically are metal structures with restricted opening that retain materials over a certain size and that have mechanisms for removing the solids from the surface of the screen. Grit removal is typically controlling velocity to cause the heavier grit (rapidly settling) particles to separate from the main wastewater flow. Some systems bypass this step and go directly on to subsequent unit operations. Lagoon systems are often without headworks, as well as without clarifiers 46 and 50, that are included in the broad scope of this invention applied to wastewater treatment system 10 in general.

Primary clarifier 46 may be any one of a circular tank, a rectangular tank, or any combination of the preceding, which may include one or more bottom scraper mechanisms. The wastewater from the headworks 52 enters the clarifier 46 where relatively quiescent conditions allow slower settling particles to fall to the tank bottom and be removed from the main wastewater flow. These solids typically require further treatment for stabilization prior to ultimate disposal.

Wastewater then flows to the biological reactor 12 that may be any one of a tank, basin, a lagoon, or any combination of any of the preceding where biological activity consumes organics and nutrients in the wastewater are accomplishing a major removal function of the wastewater treatment system 10. These reactors may be aerobic, anoxic, or anaerobic. In an aspect of the present invention, one or more controlled reaction-volume module(s) 60 may be located in a biological reactor 12.

Secondary clarifier 50 receives the effluent from the biological reactor 12 and may be any one of a circular tank, a rectangular tank, or any combination of the preceding, which may include one or more bottom scraper mechanisms. The wastewater from the biological reactor 12 enters the clarifier 34, where relatively quiescent conditions allow the growth biology grown in the biological reactor 12 and other settleable particles to fall to the tank bottom and be removed from the main wastewater flow. The majority of these settled solids may be returned to the biological reactor 12. A portion of these solids are wasted from the main wastewater flow and typically require further treatment for stabilization prior to ultimate disposal. Lagoon systems typically eliminate this step.

The wastewater proceeds on to an optional filter 48 where the liquid is passed through sand, fabric, or other fine media to remove small remaining suspended solids from the wastewater flow.

Due to the pathogens present in domestic wastewater, a disinfector 54 may be provided where oxidizing agents, ultraviolet light, or other bacterial/viral inactivation agents are applied.

Re-aerator 56 is another optional unit that may be embodied by aerators in a basin or hydraulic jumps in an effluent structure to promote the increase in dissolved oxygen level in the treated wastewater. The treated wastewater typically then goes to a receiving natural body of water or, in the case of many industrial pretreatment plants, into a receiving sewer.

In operation, wastewater containing solids, inorganic and organic components, and/or nutrients enter a wastewater treatment system 10 through headworks 52 that does an initial conditioning step to remove readily separated solids and sand and gravel from the wastewater flow. This simplifies the work required of subsequent unit operations and minimizes equipment wear. The clarifier 46 removes additional settleable solids further reducing the load on subsequent unit operations.

The biological reactor 12 may be any one of a tank, a basin, a lagoon, or any combination of any of the preceding, which is either covered or uncovered. Biological conversion is predominately done by microorganisms (growth biology). These reactors may be aerobic where aeration devices are typically used to provide mixing and dissolved oxygen to support the life cycle of the microorganisms (growth biology). Alternatively, these reactors may be anaerobic, where mixing is provided without oxygen. The byproducts of aerobic biological conversion are typically CO₂, water, and additional cell mass. The byproducts of anaerobic conversion are typically methane, carbon dioxide, water, and additional cell mass. Other biological conversion processes are anoxic, where nitrates and/or nitrites supplant oxygen as the electron donor for metabolic activity and the byproducts are (for nitrified wastewaters) nitrogen gas, water, and additional cell mass and nutrient conversion steps where intermediate reactions take place converting compounds to more environmentally friendly states.

The secondary clarifier 50 settles and returns the microorganisms (growth biology) grown in the biological reactor 10 back to the biological reactor 10 to increase the concentration of microorganisms (growth biology) and thereby allow more biological conversion to take place in the biological reactor 12 improving the efficiency and cost effectiveness of the wastewater treatment process.

Filters 48 may be used to polish the effluent to further remove the small remain suspended solids and related organics to provide a highly purified effluent. This effluent goes through a disinfector 54 where microorganisms (growth biology)/pathogens are inactivated to provide further protection to the health of the receiving body of water. In some systems, re-aeration 56 is employed to increase the dissolved oxygen level of the wastewater treatment plants effluent to further enhance the health of the receiving body of water

Turning now to FIGS. 2 and 4, there are shown elevation views of a biological reactor 12. As noted earlier, a biological reactor 12 may be any one of a tank, a basin, a lagoon, or any combination of any of the preceding. Also, a biological reactor 12 may be any one of covered, uncovered, aerated, not aerated; have natural mixing, induced mixing, or any combination of any of the preceding. The biological reactor 12 is to provide an environment to promote the biological consumption or conversion of pollutants to less harmful states.

Contained in a biological reactor 12 is one or more controlled reaction-volume module(s) 60. These modules 60 may be placed, positioned, and supported in a biological reactor 12 by a variety of mechanisms including any one of floats, side of reactor attachments/supports, bottom of reactor attachments/supports, or any combination of any of the preceding.

Biological reactor 12 and/or one or more controlled reaction-volume module(s) 60 include a number of media 14 as described above. Mixing devices 28 are positioned below and/or above of the media 14. Mixing devices 28 provide the function of controlling the mixing and/or aeration within a biological reactor 12 and/or one or more controlled reaction-volume module(s) 60. The mixing devices 28 may be individual units or multiple units and may be manifolded-together systems that may incorporate control valving to allow for controlled operation on an independent or group basis.

The mixing devices 28 may be a gas or air (pneumatic) mix (See e.g., U.S. Pat. No. 4,595,296 issued Jun. 17, 1986 entitled Method And Apparatus For Gas Induced Mixing And Blending), may be a liquid (hydraulic) mix, or combinations thereof. The mixing device 28 may be powered by a gas supply 80, which could be a compressor or blower, or powered by pumps or combinations of the two. The source of the gas may be atmospheric air, may be methane from biological activity, or may be from other commercially available gases including nitrogen. The liquid source may be from within the biological reactor 12; it may be nitrified effluent, return sludge or external.

Optionally, control sensors 44 may be incorporated into a biological reactor 12 and/or one or more controlled reaction-volume module(s) 60. Control sensors 44 may be used for overall biological reactor 12 and/or one or more controlled reaction-volume module(s) 60 control. A sensor 44 may be of a variety of types including manual in the case of removal sections of media 14 or remote process sensors for such parameters as pH, or time, or temperature, or ammonia, or nitrates, or ORP, or dissolved oxygen, or oxygen uptake rates. Information from sensors 44 may be processed automatically or manually in a controller 20. The controller 40 processes sensor inputs and controls biological reactor 12 and/or one or more controlled reaction-volume module(s) 60 function by outputs to any one of controls valves, a pneumatic power supply with a control interface, a hydraulic supply with control interface, or any combination of any of the preceding.

In operation, wastewater coming into the biological reactor 12 exhibits various characteristics and has various process demands on the treatment system to allow the system to perform as designed. A factor in optimizing the effectiveness of a biological reactor 12 may be to concentrate as many beneficial microorganisms (growth biology) as possible in the space available and to keep them performing at optimum rates. A biological reactor 12 and/or one or more controlled reaction-volume module(s) 60 may provide a controlled environment for a fixed growth high-density biological population. For effectiveness, this population may have a controlled environment. Control parameters include any one of food supply, oxygen, mixing, or any combination of any of the preceding. Controlling these parameters impact other biological variables, including the type of biology the biological reactor 12 and/or one or more controlled reaction-volume module(s) 60 may optimize.

By purposely controlling the mixing within a biological reactor 12 and/or one or more controlled reaction-volume module(s) 60, growth biology thickness may be controlled as well as control of the transport of substrate (food) and oxygen or nitrate (for aerobic or anoxic systems, respectively) within the module. Individual areas of a biological reactor 12 and/or one or more controlled reaction-volume module(s) 60 may be independently and/or periodically highly mixed/aerated to remove older and/or excess growth and provide a thinner new grow biological environment to optimize the biological reactor 12 and/or the performance of one or more controlled reaction-volume module(s) 60.

Worm predation is also an important variable to control in optimizing biological reactor performance where fixed film medias are employed. Reducing the dissolved oxygen level in the media to levels below that supporting worm populations and doing so for a controlled time frame, typically provides worm control. Individual and/or controlled grouping of biological reactor 12 and/or one or more controlled reaction-volume module(s) 60 may operate in this reduced dissolved oxygen mode while the overall biological reactor continues in full functional dissolved oxygen level biological mode. This is opposed to having to take an entire basin to very low to no dissolved oxygen (DO) for extended time frames that could have a negative impact on overall wastewater treatment plant effectiveness. The controllability allows for continual automatic online work control as part of the basic wastewater treatment system 10 operating rationale.

FIG. 3 is a plan view showing a biological reactor 12. FIG. 6 is a plan view showing four (4) controlled reaction-volume module(s) 60 manifolded together with the provision for valve isolation. Each controlled reaction-volume module 60 contains mixing devices 28 and provision for control sensors 44. Mixing and/or aeration are provided from pneumatic sources 80 or pumping sources or any combination thereof.

Provision may be made to provide commercially available specialized bacteria (and food—wastewater or synthetic) into the module 12 (See e.g., U.S. Pat. No. 5,863,128 issued Jan. 26, 1999 and entitled Mixer-Injectors With Twisting And Straightening Vanes). This may be referred to as bioaugmentation. Some example of products for municipal wastewater treatment and related areas available from Novozymes Biologicals Inc. Salem, Va., USA that may be used include:

| BI-CHEM ® 2000 series | Target |
|---|---|
| BI-CHEM ® 2000GL | Fats, oils, and grease |
| BI-CHEM ® 2003MS | Cold weather BOD |
| BI-CHEM ® 2006RG | Surfactant assisted for severe grease |
| BI-CHEM ® 2008AN | Anaerobic digester grease |
| BI-CHEM ® 2009GT | Anaerobic lift stations |
| BI-CHEM ® 2010XL | Treatment plant optimization |
| BI-CHEM ® 1010 | Nitrification |
| BI-CHEM ® Odor Controller | Non-sulfide odors |
| BI-CHEM ® Nitraid ™ | Sulfide control |

Some example of products for industrial wastewater treatment and related areas available from Novozymes Biologicals Inc. Salem, Va., USA that may be used include:

| BI-CHEM ® 1000 series | Target |
|---|---|
| BI-CHEM ® 1000DL | Industrial drain lines |
| BI-CHEM ® 1002CG | Phenolics and related compounds |
| BI-CHEM ® 1003 FG | Food processing |
| BI-CHEM ® 1004TX | Surfactants |
| BI-CHEM ® 1005PP | Pulp and paper |
| BI-CHEM ® 1006KT | Acetone and related ketones |
| BI-CHEM ® 1008CB | General chemical |
| BI-CHEM ® 1738CW | Cold weather BOD |
| BI-CHEM ® ABR Hydrocarbon | Petroleum hydrocarbons |
| BI-CHEM ® 1010N | Nitrification |
| BI-CHEM ® Odor Controller | Non-sulfide odors |
| BI-CHEM ® Nitraid ™ | Alternate electron acceptor |
| BI-CHEM ® MicroTrace | Biological tracer |

This bioaugmentation may be used, for example, in lagoons where it is difficult to concentrate microorganisms or for enhancing nitrification or removal of other target compounds.

In an aspect as shown in FIGS. 1, 2, 3, 4, 5, and 6, a controller 40, in conjunction with a pump and/or a aeration mechanism 80, is configured to be capable of creating an environment within the any one of a portion of a biological reactor 12 and/or one controlled-reaction-volume module 60 that may be alternated among any one of aerobic, anoxic, anaerobic, or any combination of any of the preceding. In another aspect as shown in FIGS. 1, 2, 3, 4, 5, and 6, a controller 40 communicates with the at least one mixing device 28. For example, a controller 40 may be capable of controlling a dissolved oxygen concentration within a biological reactor 12.

Examples of a suitable controller 40 may include any one of a mechanical controller, operated manually controller, a electromechanical controller, an electronic controller, or any combination of any of the preceding. In an aspect of the invention, a controller 40 may capable of facilitating control of at least one growth-biology predator if a predator may be an issue.

Any of a number of type or kind of controllers 40 may be used such as, for example, programmable logic controllers (PLCs), manually operated controllers, time controllers, electrical controllers, mechanical controllers, electro-mechanical controllers, pneumatic controllers, or any combination of any of the preceding. Also, a controller may be integrated into a main and/or sub plant controller without a local panel. In this manner, rather than buying a controller 40, an integration of the control of the operation of a biological reactor 12 and/or a controlled-reaction-volume module 60 into the main and/or sub plant controller may be accomplished.

When present, the at least one controller 40 may communicate at least with the at least one mixing device 28. Also, the controller 40 may communicate with valves (e.g., actuated pneumatically, electrically, mechanically, hydraulically, electro-mechanically, and combinations thereof) such as solenoid valves, and/or pumps and/or sensors either located within and/or without a biological reactor 12 and/or a controlled-reaction-volume module 60.

A biological reactor 12 may include at least one and, optionally, more sensors 44. One example of a suitable sensor 44 is one capable of measuring biological activity. Another example of a suitable sensor 44 is one capable of measuring pH. Yet another example of a suitable sensor 44 is one capable of measuring dissolved oxygen (DO). Still another example of a suitable sensor 44 is one capable of measuring at least one enzyme level, such as, for example, any one of adenosine triphosphate (ATP), adenosine diphosphate (ADP), oxidation-reduction potential (ORP) ammonia, nitrates, nitrites, or any combination of any of the preceding. If appropriate, a sensor 44 may be capable of indicating a presence of a growth-biology predator, such as, for example, a worm. In an aspect, a sensor 44 may be as simple as a coupon.

Now turning to FIGS. 4, 5, and 6, which show a biological reactor 12 further including a controlled-reaction-volume module 60 and a number of a media 14 for supporting a growth biology within the controlled-reaction-volume module 60 within the biological reactor 12. Such a biological reactor 12 further may include at least one mixing device 28 capable of communicating a fluid to the at least one controlled-reaction-volume module 60. In an aspect, a mixing device 28 (e.g., high momentum mixer) communicates a fluid to a controlled-reaction-volume module 60. It will be appreciated that one controlled-reaction-volume module 60 channels or may be capable of directing a flow of fluid in the vertical direction. A controlled-reaction-volume module 60 may include a partially vertically enclosed partition 62. Alternatively, a controlled-reaction-volume module 60 may include a substantially completely vertically enclosed partition 62. In either case, a controlled-reaction-volume module 60 further may include a flow director 64 that may extend at least a portion of a partition 62 beyond the media 14. As with a screen 30, a controlled-reaction-volume module 60 may be sized with openings smaller than the smaller dimension of a media 14. For example, an opening of the controlled-reaction-volume module 60 may be about ⅔ of the smaller dimension of a media 14. A controlled-reaction-volume module 60 may be constructed using a material possessing corrosion resistance, such as, for example, stainless steel. Also, controlled-reaction-volume module 60 may be constructed of any one of a wedgewire, a round wire, a perforated and expanded metal, or any combination of any of the preceding.

It will be appreciated that an environment within a controlled-reaction-volume module 60 may be controlled to be any one of one aerobic, anoxic, anaerobic, or any combination of any of the preceding. Further, such environment may be alternated among any one of aerobic, anoxic, anaerobic, or any combination of any of the preceding.

In a biological reactor 12, a controlled-reaction-volume module 60 further may include a support mechanism 66, such as, for example, any one of a flotation mechanism, a floor stand, a suspension mechanism, or any combination of the preceding. For example, a suspension mechanism may be any one of within the biological reactor 12, from a top of the biological reactor 12, or any combination of the preceding.

Returning to FIGS. 4 and 5, a biological reactor 12 further may include at least one additional controlled-reaction-volume module 60′. In such a case, each of the at least two controlled-reaction-volume modules (60 and 60′) may be capable of being alternated among any one of aerobic, anoxic, anaerobic, or any combination of the preceding. Such alternating among any one of aerobic, anoxic, anaerobic, or any combination of the preceding may be done independently for each of the at least two controlled-reaction-volume modules 60. Thus, it will be appreciated that a biological reactor 12 may include a plurality of controlled-reaction-volume modules 60, 60′, 60″, etc. Again, the plurality controlled-reaction-volume modules 60, 60′, 60″, . . . etc. may be capable of being alternated among any one of aerobic, anoxic, anaerobic, or any combination of the preceding. Once again, such alternating among any one of aerobic, anoxic, anaerobic, or any combination of the preceding may be independent for each of the plurality of controlled-reaction-volume modules 60, 60′, 60″, . . . etc.

Turning now to growth biology, in an aspect, a thickness of growth biology may be such that it encourages autotrophic organisms. For example, a thickness of growth biology may be such that there is a preponderance of aerobic organisms versus anaerobic organisms. Alternatively, a thickness of growth biology may be such that it is capable of substantially maintaining a surface area of the media 14.

Returning to the mixing device 28 of FIGS. 1, 2, 3, 4, 5, and 6, it may be a bubble generator including any one of a large coarse bubble generator, a medium bubble generator, a fine bubble generator, or any combination of any of the preceding. In an aspect, a mixing device 28 may be a high momentum including any one of a jet mixer, a jet aerator, a mechanical mixer, a pump, or any combination of any of the preceding.

In another aspect as depicted in FIGS. 2, 3, 5, and 6, a biological reactor 12 further may include an aeration mechanism 80, such as, for example, a bubble generator.

In operation, wastewater enters the biological reactor 12 for treatment and flow onto the next unit operation. Suspended growth microorganisms (growth biology) grow, are concentrated by returning underflow from the secondary clarifier 34, and consume pollutants. In order to enhance the removal characteristics of the biological reactor 12, fixed film media is added to the biological reactor 12 to increase the biological effectiveness and provide enhanced biology and control of biology. Without limitation, typical applications may include: anoxic, aerobic, heterotrophic growth, and nitrifying organisms.

Anoxic: Biological reactor 12 and/or controlled-reaction-volume module 60 have flow induced without the introduction of dissolved oxygen. An enhanced function is for returned nitrified effluent to be returned directly into the biological reactor 12 and/or controlled-reaction-volume module 60 to both facilitate mixing and biological conversion.

Aerobic: Aeration is conducted in the basin by conventional means including diffused aeration and surface mechanical aeration. Media 14 of biological reactor 12 and/or controlled-reaction-volume module 60 grows high densities of desirable microorganisms (growth biology). Flow is induced through the biological reactor 12 and/or controlled-reaction-volume module 60 by the mixing device 28. Due to the high rate of microbial activity, high growth rates may occur, resulting in thick film growth on the fixed film media. By controlling the mixing intensities within the biological reactor 12 and/or controlled-reaction-volume module 60 through control of the mixing device 28, the film thickness and resultant biological effectiveness may be controlled and optimized.

Biological reactor 12 and/or controlled-reaction-volume module 60 may have high-rate mixing cycles independently or in groups programmed into the controller 40 based upon sensor 44 to purge excess growth to maintain overall operational maximum efficiencies.

Biological reactor 12 and/or controlled-reaction-volume module 60 may also individually or in groups be subjected to low to no dissolved oxygen environments by stopping mixing devices 28. This condition promotes the worm cure environment on a module-specific basis. The worms will release and exit the module. Excessive worm growth may be especially detrimental to modules specifically dedicated to nitrification.

Biological reactor 12 and/or controlled-reaction-volume module 60 may also individually or in groups be subjected to low to no dissolved oxygen environments by stopping mixing devices 28. This condition may be utilized to force bacteria to use the ammonia converted during aerobic operation into nitrites/nitrates as the electron donor, thereby further reducing nitrogen compounds for more complete treatment.

Heterotrophic growth: Heterotrophic growth is very fast-growing and typically focused on consumption of organics quantified as BOD (Biochemical Oxygen Demand). Worms for media 14 of the present invention in heterotrophic applications typically are not a problem and may actually be beneficial due to their reduction in net waste sludge.

Nitrifying organisms: Nitrifying organisms are autotrophic and necessary for many current advanced wastewater treatment applications. Nitrifiers are relatively slow-growing, and the predation on them by worms can adversely affect population densities needed for effective treatment.

The ability of biological reactor 12 and/or controlled-reaction-volume module 60 to control the reactor environment (dissolved oxygen content in this case) provides for controlling the worm population independent of entire basin environment, and thereby optimizes efficiencies of basin utilization and bacterial diversity.

For example, in a logic sequence for biological reactor 12 and/or controlled-reaction-volume module 60 operation, one module is in “worm cure mode”. This module may have no mixing. Dissolve oxygen level are “none non-detect”. The timer puts this mode into effect for 18 hours. The timer also reinitiates this mode again in 12 days to capture the inactivation of the reproductive life cycle of the undesired organism.

The controller 40 initiates these cycles to individual modules or groups of modules to minimize the number of modules that are off aerobic line at any one time.

Based upon sensor 44 inputs, mixing is periodically significantly increased to promote removal of excessive biological growth and maintain optimum reactor effectiveness. Controller 40 maintains continuity, hierarchy of operations, and control by operations.

FIG. 10 represents the logic pathway of the controller 40 and sensors 44. The logic pathway is initiated at 400. A signal passes from 410 to 402 and then to 404. Boxes 402 and 404 represent sensors that can detect settings such as biological activity, pH, dissolved oxygen, enzymes, ATP, ADP, Ammonia, Nitrates, ORP, or predator presence in order to vary the activity of the mixing device 28 through the controller 40. Box 406 is a decision point. If a sensor 44 is triggered, then the signal moves to Box 408 and eventually loops to Box 402. Box 408 changes the speed of the mixing device 28 from off to maximum depending on the value the sensors represented by 402 and 404 detected. The signal then loops back through to 402 to detect if a sensor has been triggered again.

Accordingly, one aspect of the present invention is to provide a wastewater treatment system including a biological reactor. A number of a media for supporting growth biology are located in the biological reactor. Each media includes a tubular cross-section and a perturbated outer perimeter. The perturbated outer perimeter creates a protected outer surface area for supporting growth biology.

Another aspect of the present invention is to provide a biological reactor including a number of a media located in the biological reactor and for supporting a growth biology. Each media includes a tubular cross-section and a non-nesting perturbated outer perimeter. The non-nesting perturbated outer perimeter creates a protected outer surface area for supporting a growth biology.

Still another aspect of the present invention is to provide a wastewater treatment system including a biological reactor. A number of a media for supporting a growth biology are located in the biological reactor. Each media includes a tubular cross-section and a non-nesting perturbated outer perimeter. The non-nesting perturbated outer perimeter creates a protected outer surface area for supporting a growth biology. At least one screen sized so as to facilitate retention of the number of media within the biological reactor may also be provided.

Turning now to FIG. 8 that shows a number of media 14 of the present invention and that outer surface area 22 of each media 14 is protected from collisions. Further, FIG. 8 shows that a media 14 of the present invention may include a non-nesting perturbated outer perimeter 20. The media 14 of FIG. 8 can be contrasted with the prior art media shown in FIGS. 10 and 11 because all outer surfaces may come into contact with other outer surfaces and, thus, are kept free from growth biology through growth biology wear. Furthermore, the media 14 of the present invention have a design allowing a good transfer of oxygen and organic matter to growth biology.

Certain modifications and improvements will occur to those skilled in the art upon a reading of the foregoing description. By way of example, a radial section connecting a perimeter 20 to the outer surface area 22 may be angled in a manner offset from the centerline of a media 14 to create a larger outer surface area 22 than would occur if the forgoing radial section were in a line intersecting the centerline of the media 14 as shown in FIG. 7. Also, a perturbated outer perimeter 20 may be perturbed as a spiral form or spiral structure or helix to create a protected outer surface area 22 for supporting growth biology that lies on a surface of the media 14, so that its angle to a plane perpendicular to the axis of the media 14 is substantially constant. In this manner, surface area and/or mixing may be increased. It should be understood that all such modifications and improvements have been deleted herein for the sake of conciseness and readability but are properly within the scope of the following claims.

We claim:

1. A wastewater treatment system comprising:
(a) a biological reactor; and
(b) a number of a media for supporting a growth biology within the biological reactor, each media including:
(i) a tubular cross-section, and
(ii) a perturbated outer perimeter that creates a protected outer surface area for supporting a growth biology.

2. The wastewater treatment system according to claim 1, wherein the biological reactor further includes at least one screen sized so as to facilitate a retention of the number of media within the biological reactor.

3. The wastewater treatment system according to claim 1, wherein the biological reactor further includes at least one mixing device.

4. The wastewater treatment system according to claim 3, wherein the biological reactor further includes at least one controller 40.

5. The wastewater treatment system according to claim 4, wherein the at least one controller 40 is capable of alternating an environment within the at least one controlled-reaction-volume module among any one of aerobic, anoxic, anaerobic, or any combination of any of the preceding.

6. The wastewater treatment system according to claim 4, wherein the at least one controller communicates with the at least one mixing device.

7. The wastewater treatment system according to claim 4, wherein the at least one controller includes any one of a mechanical controller, an operated manually controller, an electromechanical controller, an electronic controller, or any combination of any of the preceding.

8. The wastewater treatment system according to claim 4, wherein the at least one controller is capable of facilitating control of at least one growth-biology predator.

9. The wastewater treatment system according to claim 4, wherein the at least one controller is capable of controlling a dissolved oxygen concentration within the biological reactor.

10. The wastewater treatment system according to claim 1, wherein the biological reactor further includes at least one sensor.

11. The wastewater treatment system according to claim 10, wherein the at least one sensor is capable of measuring biological activity.

12. The wastewater treatment system according to claim 10, wherein the at least one sensor is capable of measuring pH.

13. The wastewater treatment system according to claim 10, wherein the at least one sensor is capable of measuring dissolved oxygen (DO).

14. The wastewater treatment system according to claim 10, wherein the at least one sensor is capable of measuring at least one enzyme level.

15. The wastewater treatment system according to claim 14, wherein the at least one enzyme level is a level of one of adenosine triphosphate (ATP), adenosine diphosphate (ADP), oxidation-reduction potential (ORP), ammonia, nitrates, nitrites, or any combination of any of the preceding.

16. The wastewater treatment system according to claim 10, wherein the at least one sensor is capable of indicating a presence of a growth-biology predator.

17. The wastewater treatment system according to claim 16, wherein the at least one sensor is a coupon.

18. The wastewater treatment system according to claim 16, wherein the growth-biology predator is a worm.

19. The wastewater treatment system according to claim 2, further including at least one clarifier upstream from the biological reactor.

20. The wastewater treatment system according to claim 1, further including at least one additional clarifier downstream from the biological reactor.

21. The wastewater treatment system according to claim 1, further including at least one headworks upstream from the biological reactor.

22. The wastewater treatment system according to claim 1, further including at least one disinfector downstream from the biological reactor.

23. The wastewater treatment system according to claim 1, further including at least one at least one aerator downstream from the biological reactor.

24. The wastewater treatment system according to claim 1, further including a controlled-reaction-volume module within the biological reactor, the number of a media for supporting a growth biology within the controlled-reaction-volume module within the biological reactor.

25. The wastewater treatment system according to claim 24, further including at least one mixing device capable of communicating a fluid to the at least one controlled-reaction-volume module.

26. The wastewater treatment system according to claim 25, wherein the at least one mixing device includes at least one high momentum mixer for communicating a fluid to the at least one controlled-reaction-volume module.

27. The wastewater treatment system according to claim 26, wherein the at least one controlled-reaction-volume module is capable of growth-biology predator control.

28. The wastewater treatment system according to claim 27 where the controlled growth-biology predators are worms.

29. The wastewater treatment system according to claim 24, wherein the at least one controlled-reaction-volume module channels a flow of the fluid in the vertical direction.

30. The wastewater treatment system according to claim 27, wherein the at least one controlled-reaction-volume module contains a partially vertically enclosed partition.

31. The wastewater treatment system according to claim 30, wherein the at least one controlled-reaction-volume module contains a substantially completely vertically enclosed partition.

32. The wastewater treatment system according to claim 24, wherein the at least one controlled-reaction-volume module further includes a flow director.

33. The wastewater treatment system according to claim 32, wherein the flow director is an extension of at least a portion of a partition of the controlled reaction volume module beyond the fixed film media.

34. The wastewater treatment system according to claim 24, wherein an environment within the at least one controlled-reaction-volume module is aerobic, anoxic, anaerobic, or any combination of any of the preceding.

35. The wastewater treatment system according to claim 24, wherein an environment within the at least one controlled-reaction-volume module is capable of being alternated among any one of aerobic, anoxic, anaerobic, or any combination of any of the preceding.

36. The wastewater treatment system according to claim 24, wherein the at least one controlled-reaction-volume module further includes at least one support mechanism.

37. The wastewater treatment system according to claim 36, wherein the at least one support mechanism includes any one of a flotation mechanism, a floor stand, a suspension mechanism, or any combination of the preceding.

38. The wastewater treatment system according to claim 37, wherein the suspension mechanism is any one of within the biological reactor, from a top of the biological reactor, or any combination of the preceding.

39. The wastewater treatment system according to claim 24, further including at least one additional controlled-reaction-volume module.

40. The wastewater treatment system according to claim 39, wherein each of the at least two controlled-reaction-volume modules are capable of alternating among any one of aerobic, anoxic, anaerobic, or any combination of the preceding.

41. The wastewater treatment system according to claim 40, wherein the alternating among any one of aerobic, anoxic, anaerobic, or any combination of the preceding is capable of being independent for each of the at least two controlled-reaction-volume modules.

42. The wastewater treatment system according to claim 41, further including a plurality of controlled-reaction-volume modules.

43. The wastewater treatment system according to claim 42, wherein each of the plurality controlled-reaction-volume modules are capable of alternating among any one of aerobic, anoxic, anaerobic, or any combination of the preceding.

44. The wastewater treatment system according to claim 43, wherein the alternating among any one of aerobic, anoxic, anaerobic, or any combination of the preceding is capable of being independent for each of the plurality of controlled-reaction-volume modules.

45. The wastewater treatment system according to claim 24, wherein a thickness of growth biology is such that it encourages autotrophic organisms.

46. The wastewater treatment system according to claim 24, wherein a thickness of growth biology is such that there is a preponderance of aerobic organisms versus anaerobic organisms.

47. The wastewater treatment system according to claim 24, wherein a thickness of growth biology is such that it is capable of substantially maintaining a surface area of the media.

48. The wastewater treatment system according to claim 24, wherein the at least one mixing device is a bubble generator.

49. The wastewater treatment system according to claim 48, wherein the bubble generator is a coarse bubble generator.

50. The wastewater treatment system according to claim 49, wherein the bubble generator includes any one of a large coarse bubble generator, a medium bubble generator, a fine bubble generator, or any combination of any of the preceding.

51. The wastewater treatment system according to claim 24, wherein the at least one mixing device is a high momentum including any one of a jet mixer, a jet aerator, a mechanical mixer, a pump, or any combination of any of the preceding.

52. The wastewater treatment system according to claim 24, further including an aeration mechanism.

53. The wastewater treatment system according to claim 51, wherein the aeration mechanism is a bubble generator.

54. The wastewater treatment system according to claim 24, wherein the wastewater treatment system is any one of a municipal wastewater treatment facility, an industrial wastewater treatment facility, a commercial wastewater treatment facility, a ship wastewater treatment facility, an agricultural wastewater treatment facility, or any combination of any of the preceding.

55. A media for supporting a growth biology within the biological reactor of a wastewater treatment system, the media comprising:
(a) a tubular cross-section; and
(b) a non-nesting perturbated outer perimeter that creates a protected outer surface area for supporting a growth biology.

56. The media according to claim 55, wherein the tubular cross-section includes any one of an oval cross-section, an elliptical cross-section, a polygonal cross-section, or any combination of any of the preceding.

57. The media according to claim 55, wherein the oval cross-section includes any one of an egg cross-section, a track cross-section, or any combination of any of the preceding.

58. The media according to claim 56, wherein the elliptical cross-section includes a circular cross-section.

59. The media according to claim 56, wherein the polygonal cross-section includes any one of a simple polygonal cross-section, a complex polygonal cross-section, a convex polygonal cross-section, a concave polygonal cross-section, a concyclic or cyclic polygonal cross-section, a regular polygonal cross-section, or any combination of any of the preceding.

60. The media according to claim 55, further including an interior structure creating surface areas for supporting a growth biology.

61. The media according to claim 59, wherein a portion of the interior surfaces includes a potion of the perturbated outer perimeter.

62. The media according to claim 59, wherein a portion of the interior structure provide support to the outer perimeter.

63. The media according to claim 59, wherein the interior structure include a distribution within the outer perimeter so as to substantially avoid a bridging of growth biology in a space defined by an interior structure and/or the outer perimeter.

64. The media according to claim 59, wherein a portion of the interior structure include perturbated surface areas.

65. The media according to claim 55, wherein the interior perturbated surface areas include a distribution so as to substantially avoid a bridging of growth biology in a space defined by the interior structure and/or the outer perimeter.

66. The media according to claim 64, wherein the perturbated outer perimeter facilitates a mixing of the media.

67. The media according to claim 65, wherein the mixing of the media includes any one of a tumbling of the media, a rotating of the media, or a tumbling and a rotating of the media.

68. The media according to claim 55, wherein the media includes an aspect ratio (nominal length to nominal diameter ratio) of between about 0.3 and about 1.

69. The media according to claim 55, wherein the protected outer surface area for supporting a growth biology comprises between about 30 to about 70 percent of the outer surface area.

70. The media according to claim 68, wherein the protected outer surface area for supporting a growth biology comprises between about 40 to about 60 percent of the outer surface area.

71. The media according to claim 69, wherein the exterior surface includes an arrangement so as to substantially avoid a bridging of growth biology in a space defined by the perturbated outer perimeter.

72. The media according to claim 55s, wherein a specific gravity of the media is between about 0.9 and about 1.2.

73. The media according to claim 71, wherein the fixed-film media is a polymer.

74. The media according to claim 72, wherein polymer includes any one of any one of a polyethylene, a polypropylene, a polyvinylchloride, or any combination of any of the preceding.

75. A wastewater treatment system comprising:
(a) a biological reactor; and
(b) a number of a media for supporting a growth biology within the biological reactor, each media including:
(i) a tubular cross-section, and
(ii) a non-nesting perturbated outer perimeter that creates a protected outer surface area for supporting a growth biology; and
(c) at least one screen sized so as to facilitate a retention of the number of media within the biological reactor.

76. A method for treating wastewater, the method comprising the steps of:
(a) providing a biological reactor;
(b) providing a number of a media for supporting a growth biology to the biological reactor, each media including:
(i) a tubular cross-section, and
(ii) a perturbated outer perimeter that creates a protected outer surface area for supporting a growth biology; and
c) communicating a fluid to the biological reactor so that the wastewater and growth biology communicate, thereby treating the wastewater.

77. A method for treating wastewater, the method comprising the steps of:
(a) providing a biological reactor;
(b) providing at least one controlled-reaction-volume module to a biological reactor;
(c) providing a number of a media for supporting a growth biology to the biological reactor, each media including:
(i) a tubular cross-section, and
(ii) a perturbated outer perimeter that creates a protected outer surface area for supporting a growth biology; and
(d) providing wastewater to the at least one controlled-reaction-volume module; and
(e) communicating a fluid to the at least one controlled-reaction-volume module at a momentum so that the wastewater and growth biology communicate, thereby treating the wastewater.

78. A method for treating wastewater, the method comprising the steps of:
(a) providing a biological reactor;
(b) providing a number of a media for supporting a growth biology to the biological reactor, each media including:
(i) a tubular cross-section, and
(ii) a non-nesting perturbated outer perimeter that creates a protected outer surface area for supporting a growth biology; and
(c) communicating a fluid to the biological reactor so that the wastewater and growth biology communicate, thereby treating the wastewater; and
(d) controlling at least one characteristic of the communicating fluid to thereby treat the wastewater.
